(19) United States
(12) Patent Application Publication
(10) Pub. No.: US 2011/0320240 A1
(43) Pub. Date: Dec. 29, 2011

(54) VIDEO-BASED ANALYSIS WORKFLOW PROPOSAL TOOL

(75) Inventors: ROMELIA H. FLORES, KELLER, TX (US); CHARLET N. GIVENS, DALLAS, TX (US); SHIJU MATHAI, CARROLLTON, TX (US)

(73) Assignee: INTERNATIONAL BUSINESS MACHINES CORPORATION, ARMONK, NY (US)

(21) Appl. No.: 12/824,712

(22) Filed: Jun. 28, 2010

(51) Int. Cl. G06K 9/68; G06Q 10/00

(52) U.S. Cl. 705/7.27; 382/218

(57) ABSTRACT

Video of work being performed in a place of business can be analyzed. Patterns can be identified and scored within the work when analyzing the video. The identified patterns can be correlated with business processes of a business process management system of the business. In one embodiment, the tasks performed can be to monitor a business process flow, to update a business process flow, and/or to create a new business process flow. Business process flows can be written in a standardized business process execution language or other standards based languages.

### BACKGROUND

The present invention relates to the field of business process management and, more particularly, to a video-based analysis workflow proposal tool.

An important aspect of business process management (BPM) is the documentation and improvement of the various workflows that represent business processes. A wide variety of software applications and suites (e.g., BPM systems) exist to assist organizations with these tasks. These BPM systems function by creating a software model from user-inputted operating parameters.

While the use of software models provides benefit, the parameters used to create them do not always reflect the actual operating conditions encountered on the work floor. For example, the time required to perform a specific workflow step is typically measured and inputted into the workflow model. However, the measured time often lacks a breakdown of how the time is spent on the various substeps of the workflow step. That is, the amount of time spent individually by workers and machines is often overlooked.

People may attempt to manually quantify the time spent on each substep of a workflow step. However, in a fast-paced assembly line, these measured values will be fraught with errors and inconsistencies, which then introduce the errors/inconsistencies into the software model.

### BRIEF SUMMARY

One aspect of the disclosure can include a method, computer program product, system, and/or apparatus for utilizing video with business work processes. In the aspect, video of work being performed in a place of business can be analyzed. Patterns can be identified within the work when analyzing the video. Patterns can consist of detailed work flow steps that can then be leveraged for analysis. These analyzed patterns can be compared to existing patterns stored in the pattern library (or a business process management governance system). The disclosed solution can make use of the pattern recognition and the analysis done on those patterns to automatically create the work steps. Once the video analysis has been done and the patterns of the workflow identified analytics are able to be leveraged to provide context for the segmentation and creation of workflow process steps. These steps can be used to create recommendations based on the analyzed video.

For instance, in one embodiment, recognized patterns can be compared against an existing workflow process to determine deviations and similarities. These deviations and similarities can be used for compliance monitoring of documented processes, for updating existing workflow processes, to evaluate worker performance, for training purposes, and the like. Business process flows can be written in a standardized business process execution language or can be written in accordance with other standards (e.g., XML).

One aspect of the disclosure can include a business process management system that includes a video processing tool and a workflow proposal engine. The video processing tool can receive workflow video data. The workflow video data can show work being performed in a place of business within a set of time sequenced images. The tool can process the workflow video data to determine business workflow patterns within the workflow video data. In one embodiment, patterns in the video can be analyzed and compared against a set of preexisting patterns, which can be mapped to process steps. Thus, the analyzed comparison can be used to determine a set of steps being performed within the video.

In one embodiment, the workflow proposal engine can generate workflow proposal documents by correlating business workflow patterns determined by the business processing tool against business workflows managed by the business process management system. The workflow proposal document can include a new workflow definition, workflow recommendations, hazard recognition data, standards compliance information, and other such data. The video processing tool and the workflow proposal engine can include computer program products stored on a tangible medium that are operable to run on hardware.

### BRIEF DESCRIPTION OF THE SEVERAL VIEWS OF THE DRAWINGS

FIG. 1 is an illustration depicting the data input/output flow for a video-based workflow proposal tool in accordance with embodiments of the inventive arrangements disclosed herein.

FIG. 2 is a schematic diagram illustrating a system that utilizes a workflow proposal tool in accordance with an embodiment of the inventive arrangements disclosed herein.

FIG. 3 is a flow chart of a method describing an operational overview of the workflow proposal tool in accordance with an embodiment of the inventive arrangements disclosed herein.

FIG. 4 is a flow chart of a method detailing the generation of a workflow proposal document for a known workflow process by the workflow proposal tool in accordance with embodiments of the inventive arrangements disclosed herein.

### DETAILED DESCRIPTION

The disclosure provides a solution that provides video-based workflow proposal tool. The workflow proposal tool can analyze one or more items of video data to determine the data representing the performance of a workflow. This can be done by determining patterns in the video, and comparing these patterns to known ones. Known patterns can be indexed, mapped, related, or otherwise correspond to behavior, steps, or processes, which can also be defined within workflows. In this manner, analyzed video can be used to derive workflow steps and/or to determine whether activities in the video correspond to existing workflow steps or not.

Stated in a different fashion and in accordance with one contemplated embodiment, the workflow video data can be provided to the workflow proposal tool as a real-time or near real-time video feed or as a stored recording. The performance data can then be compared against previous analyses of the same workflow contained in a workflow pattern library. Various data analysis operations can be performed upon the performance data and their comparison to the workflow pattern library. The determined output data can be formatted and compiled into a user-selected workflow proposal document. The workflow proposal document can include a new workflow definition, workflow recommendations, hazard recognition data, standards compliance information, and other such data.

Hence, the disclosure analyzes video content to generate a series of steps which are considered patterns. The patterns are then able to be further analyzed to make recommendations for improvements, to determine compliance with documented processes, and other such activities. The disclosure integrates video content with business processes analytics tools so that streamlining of processes captured in video can be performed.

Business processes can be a collection of related, structured activities that produce a service or product that meets the needs of a customer. A business process work flow is designed to increase visibility of business processes, which execute across computing systems, which can belong to different companies and/or divisions. To achieve this abstraction, special business process flow languages, similar to the business process execution language (BPEL), are used to construct business process flows. Business process workflows conforming to a business process model can be implemented in a service oriented architecture environment in one contemplated embodiment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

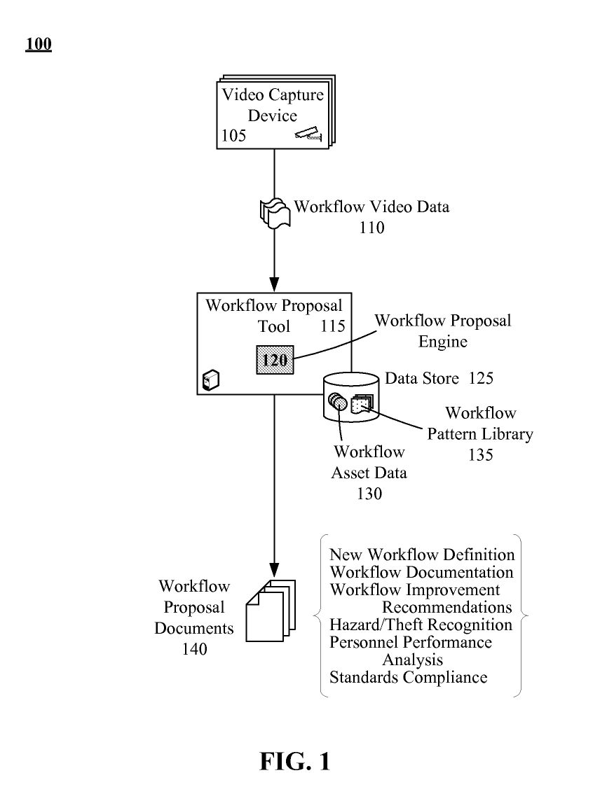

FIG. 1 is an illustration 100 depicting the data input/output flow for a video-based workflow proposal tool 115 in accordance with embodiments of the inventive arrangements disclosed herein. In illustration 100, the workflow proposal tool 115 can synthesize workflow video data 110 into a variety of workflow proposal documents 140.

The workflow video data 110 can be obtained from one or more video capture devices 105. The video capture devices 105 can represent a variety of electronic devices capable of video recording, such a video camera. Placement and orientation of the video capture devices 105 can be such as to provide a predetermined field of view for the workflow process being examined. The workflow video data 110 can represent a continuous feed from or a recorded segment made by the video capture devices 105 for a workflow process. For example, the workflow video data 110 can comprise any ordered, time sequence of images that may optionally include time sequenced audio synchronized against the images.

The workflow proposal tool 115 can represent a software application configured to process the workflow video data 110 for a workflow process into one or more workflow proposal documents 140. The workflow proposal tool 115 can define a series of steps based on analyzing video content. These steps can correspond to patterns, which can be further analyzed to make recommendations, improvements, or to monitor compliance of actual processes versus documented ones. In an embodiment that utilizes sufficiently advanced pattern recognition, workflow steps can be created and scored automatically by tool 115.

In one embodiment, the patterns detected and scored by the tool 115 can be compared against those of the workflow pattern library 135. These patterns (of library 135) can correspond to workflow steps, processes, incidents, or events of interest. For example, the pattern library 135 can include patterns corresponding to correct processes, to emergency situations, to inefficient behaviors, to patterns representing indicia of an expertise level in performing a task, and the like. A level of a match (e.g., as determined by the corresponding score) between the detected patterns in the video data 110 and those of the pattern library 135 can be used to determine behavior shown in the video in context of the workflow. Hence, tool 115 can be used to determine what processes and process steps are being performed with the video as well as to determining a level of skill (e.g., quality metrics) with which the steps are being performed.

To generate the workflow proposal documents 140, the workflow proposal tool 115 can utilize a workflow proposal engine 120, workflow asset data 130, and a workflow pattern library 135. The workflow proposal document 140 can include a new workflow definition, workflow recommendations, hazard recognition data, standards compliance information, and other such data.

Turning back to system 100, the workflow video data 110 can be digitally encoded or encoded in an analog form. Analog data can be converted into a digitally encoded format by tool 115 (or by an intermediate tool). The tool 115 (or an intermediary processing element) can perform digital signal processing (DSP) operations against the workflow video data 110 to generate an intermediary result, where the intermediary result is converted into one or more of the workflow proposal documents 140.

The workflow proposal engine 120 can correspond to a software component of the workflow proposal tool 115 configured to perform various data processing operations upon the received workflow video data 110. These data processing operations can require accessing the workflow asset data 130 and/or workflow pattern library 135, depending upon the workflow proposal documents 140 being generated.

Both the workflow asset data 130 and workflow pattern library 135 can be contained within a data store 125 accessible to the workflow proposal tool 115. Further, the data store 125 can be configured to include archival storage of the workflow video data 110.

The workflow asset data 130 can contain information pertaining to the assets, mechanical and human, involved in the workflow process. Examples of workflow asset data 130 can include, but are not limited to, machine serial numbers, part numbers, part manufacturers, service logs, and the like.

The workflow pattern library 135 can represent a collection of workflow video data 110, each defining a specific workflow process. Thus, the workflow proposal engine 120 can compare the entirety and/or individual steps of workflow process received as workflow video data 110 against those contained in the workflow pattern library 135.

It should be noted that the workflow patterns contained in the workflow pattern library 135 need not represent an optimal performance or quality standard of a workflow process. While the workflow proposal tool 115 can be used for process optimization, it is not limited in that regard.

In addition, the workflow pattern library 135 can be expanded to include workflow patterns that illustrate unwanted or inappropriate conditions. For example, pattern data illustrating hazardous operating conditions (e.g., fires, mechanical breakdowns, etc.).

The workflow proposal documents 140 can represent a variety of formatted data reports generated by the workflow proposal tool 115. Workflow proposal documents 140 can include, but are not limited to, new workflow definition, workflow documentation, workflow improvement recommendations, hazard recognition, personnel performance analysis, standards compliance, and the like. The workflow proposal documents 140 can be written in a variety of computer-interpretable languages depending upon usage.

For example, a workflow proposal document 140 meant for import and execution by a business process management system can be written in a business process execution language (BPEL), whereas reports 140 meant for review can be expressed in an extensible markup language (XML).

As used herein, presented data store 125 can be a physical or virtual storage space configured to store digital information. Data store 125 can be physically implemented within any type of hardware including, but not limited to, a magnetic disk, an optical disk, a semiconductor memory, a digitally encoded plastic memory, a holographic memory, or any other recording medium. Data store 125 can be a stand-alone storage unit as well as a storage unit formed from a plurality of physical devices. Additionally, information can be stored within data store 125 in a variety of manners. For example, information can be stored within a database structure or can be stored within one or more files of a file storage system, where each file may or may not be indexed for information searching purposes. Further, data store 125 can utilize one or more encryption mechanisms to protect stored information from unauthorized access.

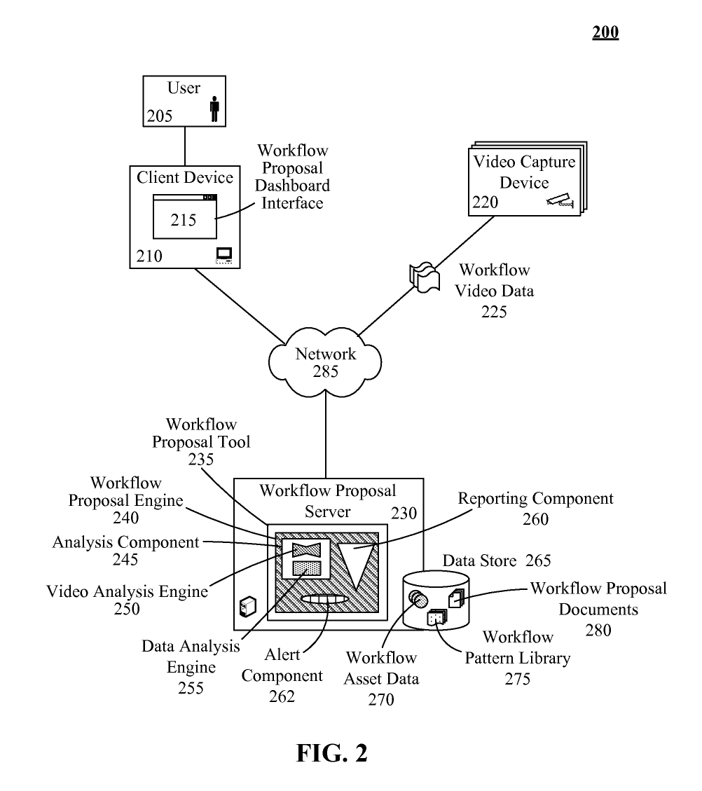

FIG. 2 is a schematic diagram illustrating a system 200 that utilizes a workflow proposal tool 235 in accordance with embodiments of the inventive arrangements disclosed herein. In system 200, the user 205 can interact with the workflow proposal tool 235 over the network 285 via a workflow proposal dashboard interface 215 to create workflow proposal documents 280.

The workflow proposal tool 235 can run upon a workflow proposal server 230 having access to a data store 265 housing workflow asset data 270, the workflow pattern library 275, and workflow proposal documents 280. In an alternate embodiment, the contents of data store 265 can be contained within multiple data stores 265 accessible by the workflow proposal server 230 over the network 285.

The workflow proposal server 230 can represent the hardware and/or software required to support operation of the workflow proposal tool 235. Additionally, the workflow proposal server 230 can be configured to interact with other elements (e.g., a business process management system, configuration management system, etc.) of an enterprise computing system via network 285.

As discussed in FIG. 1, the workflow proposal tool 235 can represent a software application designed to generate various workflow proposal documents 280 using workflow video data 225, the workflow asset data 270, and the workflow pattern library 275. The workflow video data 225 can be recorded by video capture devices 220 and fed directly to the workflow proposal tool 235 in real-time or near real-time to store for later use, or can be stored upon a data server (not shown) and accessed by the workflow proposal tool 235.

The workflow proposal tool 235 can include the workflow proposal dashboard interface 215 and workflow proposal engine 240. The workflow proposal dashboard interface 215 can represent a graphical user interface (GUI) that allows the user 205 to utilize the functionality of the workflow proposal tool 235. The user 205 can utilize the workflow proposal dashboard interface 215 to enter/modify metadata fields describing the workflow asset data 270 and/or workflow pattern library 275 as well as to configure various parameters affecting the operations of the workflow proposal tool 235.

The workflow proposal engine 240 can be comprised of an analysis component 245, a reporting component 260, and an alert component 262. The analysis component 245 can represent the elements of the workflow proposal engine 240 configured to support analysis functions of the workflow video data 225. The analysis component 245 can include a video analysis engine 250 and a data analysis engine 255.

The video analysis engine 250 can be a software application configured to examine workflow video data 225 to determine a variety of data about the workflow process and/or workflow step being performed. Examples of data determined by the video analysis engine 250 can include, but are not limited to, asset identification, identification of steps and/or substeps performed, time duration of each step/substep, motion analysis, and the like.

From the data generated by the video analysis engine 250, the data analysis engine 255 can calculate various metrics regarding the workflow process corresponding to the workflow video data 225 as required for the workflow proposal documents 280 selected by the user 205. The analyses performed by the data analysis engine 255 can require examination of the workflow asset data 270, workflow pattern library 275, and/or historical workflow proposal documents 280.

For example, for a process improvement document 280, the data analysis engine 255 can determine the differences in the time required to perform each step/substep, the assets utilized, the effect upon the organization's return on investment (ROI), as well as recommendations to improve areas that are below standard.

It is important to note that the workflow proposal tool 235, unlike conventional business process management (BPM) software tools, utilizes data in the form of workflow video data 225 and workflow pattern library 275, which represents the actual performance of the workflow being. Further, the workflow proposal tool 235 can accurately analyze the performance of substeps contained in a workflow step, leading to a more detailed view of the workflow as well as improvements.

The reporting component 260 can represent the software element of the workflow proposal engine 240 configured to generate the workflow proposal document 280 requested by the user 205. The reporting component 260 can direct the type of activities performed by the analysis component 245 to obtain the data required for the selected workflow proposal document 280. The workflow proposal document 280 generated by the reporting component 260 can then be viewed by the user 205 in the workflow proposal dashboard interface 215 and/or stored in the data store 265.

The alert component 262 can provide alerts or notifications to users when certain patterns or events occur. The patterns can be those derived from video by the analysis component 245. The alerts and/or notifications can be customizable. In one embodiment, each alert/notification provided by the alert component 262 can include a textual description of the problem, can elaborate on pattern specifics, and can also include a video segment viewable by users. These video segments can be the ones that triggered the sending of the alert. The alert component 262 can be customized to send alerts to different users via any of a variety of different devices and communication forms. For example, email alerts, text messaging alerts, voice telephony alerts, pop-up notifications, and the like can be used to convey alert and/or notification messages to a designated user responsive to patter or event occurrence.

Network 285 can include any hardware/software/and firmware necessary to convey data encoded within carrier waves. Data can be contained within analog or digital signals and conveyed though data or voice channels. Network 285 can include local components and data pathways necessary for communications to be exchanged among computing device components and between integrated device components and peripheral devices. Network 285 can also include network equipment, such as routers, data lines, hubs, and intermediary servers which together form a data network, such as the Internet. Network 285 can also include circuit-based communication components and mobile communication components, such as telephony switches, modems, cellular communication towers, and the like. Network 285 can include line based and/or wireless communication pathways.

As used herein, presented data store 265 can be a physical or virtual storage space configured to store digital information. Data store 265 can be physically implemented within any type of hardware including, but not limited to, a magnetic disk, an optical disk, a semiconductor memory, a digitally encoded plastic memory, a holographic memory, or any other recording medium. Data store 265 can be a stand-alone storage unit as well as a storage unit formed from a plurality of physical devices. Additionally, information can be stored within data store 265 in a variety of manners. For example, information can be stored within a database structure or can be stored within one or more files of a file storage system, where each file may or may not be indexed for information searching purposes. Further, data store 265 can utilize one or more encryption mechanisms to protect stored information from unauthorized access.

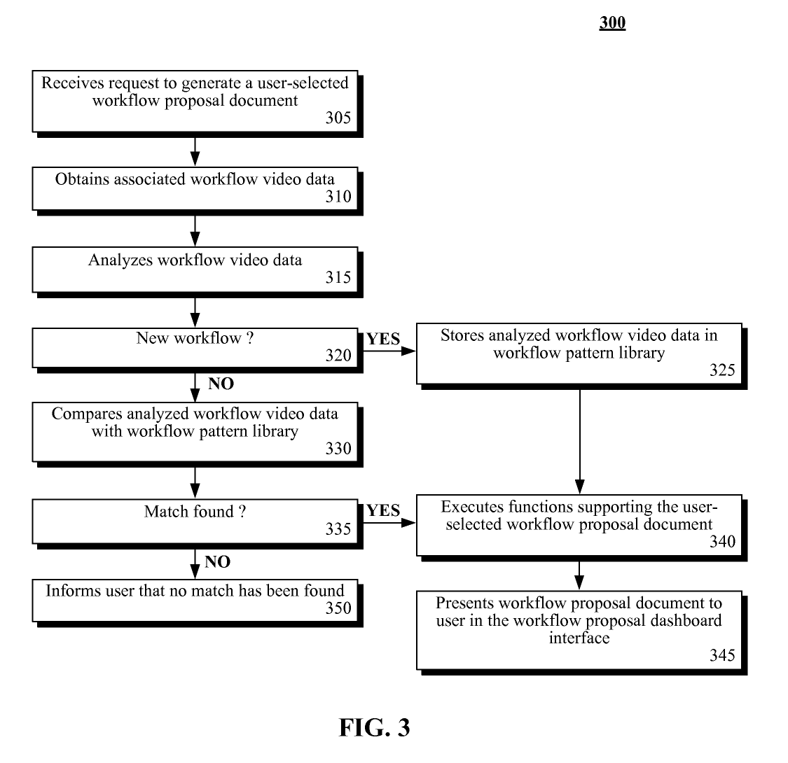

FIG. 3 is a flow chart of a method 300 describing an operational overview of the workflow proposal tool in accordance with embodiments of the inventive arrangements disclosed herein. Method 300 can be performed within the context of illustration 100 and/or system 200.

Method 300 can begin in step 305 where the workflow proposal tool can receive a request to generate a user-selected workflow proposal document. The associated workflow video data can be obtained by the workflow proposal tool in step 310. In step 315, the workflow video data can be analyzed by the analysis component.

It can be determined, in step 320, if the workflow is new (i.e., previously unprocessed). When the workflow is determined to be new, step 325 can execute where the analyzed workflow video data can be stored in the workflow pattern library.

When the workflow is not determined to be new, flow can proceed to step 330 where the analyzed workflow video data can be compared to the workflow pattern library. In step 335, it can be determined if there is a match to the analyzed workflow video data within the workflow pattern library. When a match is not found, the user can be informed, as shown by step 350.

When a match is found in the workflow pattern library or upon completion of step 325, step 340 can be performed where the workflow proposal tool can execute the functions supporting generation of the user-selected workflow proposal document. The workflow proposal document can then be presented to the user in the workflow proposal dashboard interface in step 345.

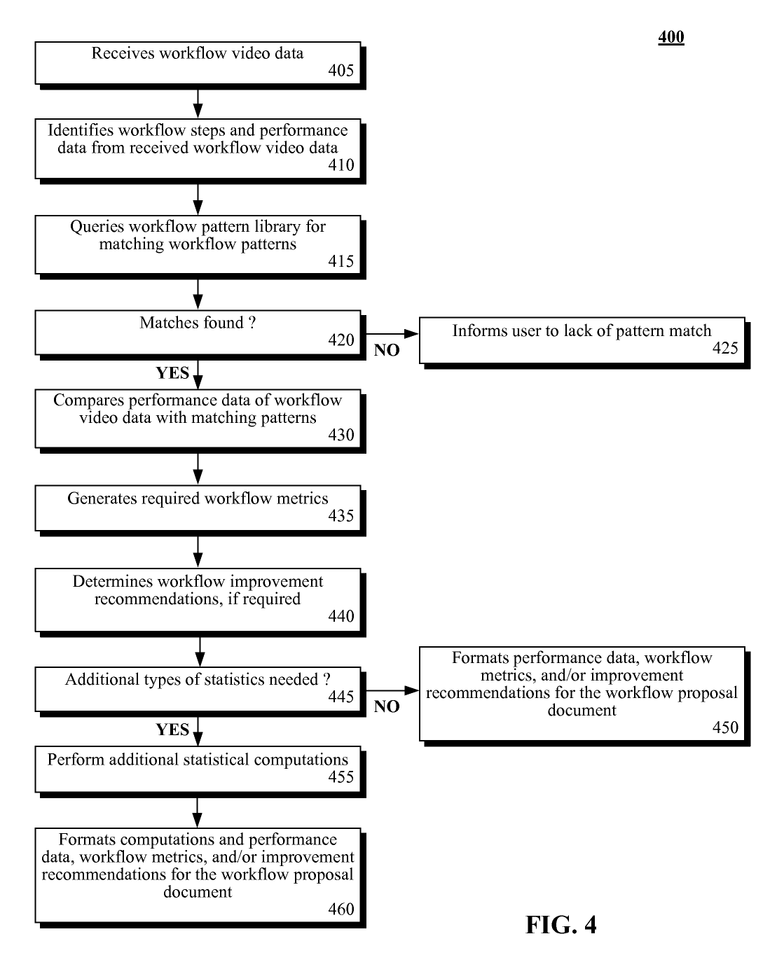

FIG. 4 is a flow chart of a method 400 detailing the generation of a workflow proposal document for a known workflow process by the workflow proposal tool in accordance with embodiments of the inventive arrangements disclosed herein. Method 400 can represent an extension of method 300.

Method 400 can begin in step 405 where the workflow proposal tool can receive workflow video data. Workflow steps and performance data can be identified from within the received workflow video data in step 410. The performance data can represent the specific details regarding the performance of the workflow, such as workflow assets being used and time duration of workflow steps.

In step 415, the workflow pattern library can be queried for workflow patterns matching the received workflow video data. Matches for the workflow video data within the workflow pattern library can be determined in step 420. When no matches are found, step 425 can execute where the user can be informed of the lack of pattern matching.

When at least one match is found, the performance data of the workflow video data can be compared with that of the matching patterns in step 430. The workflow metrics required for the workflow proposal document, if any, can then be generated in step 435. If required for the workflow proposal document, step 440 can execute to determine workflow improvement recommendations.

In step 445, the need for additional types of statistics. Various types of statistics can include, but are not limited to, a number of business steps, inefficiencies (e.g., deviations), a number of people involved, a duration of the steps, and so forth. The types of statistics used and weights afforded to each can be configured in one embodiment. When no further computations are required, flow can proceed to step 450 where the performance data, workflow metrics, and/or improvement recommendations can be formatted for the workflow proposal document.

When additional calculations are required, these computations can be performed in step 455. In step 460, the computations or computation results along with the performance data, workflow metrics, and/or improvement recommendations can be formatted for the workflow proposal document.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for utilizing video with business work processes comprising:
analyzing video of work being performed in a place of business;
detecting patterns within images of the video when analyzing the video;
comparing these detected patterns against existing patterns stored in a pattern library, where the existing patterns correspond to workflow items;
generating similarity scores for the detected patterns representing their affinity to the existing patterns;
utilizing the similarity scores to determine which workflow items are present within the video; and
performing at least one task based on the workflow items present within the video, each performed task changing or referencing a workflow of a business process management system.

2. The method of claim 1, wherein the performed task references at least one workflow of the business process management system that represents a particular specification for the work, wherein said performed task is for determining if an action captured within the video is performing to the particular specification.

3. The method of claim 1, wherein the performed task adds a new workflow to the business process management system, said new workflow comprising the workflow items determined to be present in the video.

4. The method of claim 1, wherein the performed task provides a recommendation to be analyzed by a user, wherein the recommendation is for creating a new workflow or for editing an existing workflow.

5. The method of claim 1, wherein the video is being captured and analyzed in real time or near real time, wherein the determined workflow items indicate a hazard is present in the place of business, said method further comprising:
automatically and without manual user action being required, sending a notification message that informs a recipient of the indicated hazard.

6. The method of claim 1, wherein the performed task proposes at least one recommendation based on the workflow items as compared to the referenced workflow, said method further comprising:
presenting the at least one recommendation within a graphical user interface for user selection;
receiving the user selection of at least one of the presented recommendations; and
executing a programmatic action responsive to receiving the user selection that carries out the recommendation within a computing system.

7. The method of claim 1, further comprising:
determining a plurality of distinct systematic patterns being performed during the work; and
generating a new business workflow for the business process management system that includes flows for each of the distinct systematic patterns.

8. The method of claim 1, further comprising:
capturing video of work process within a production environment of the place of business, wherein the analyzed video comprises the captured video of the production environment.

9. The method of claim 1, further comprising:
identifying patterns within the single repetitive instance of work from the analyzing of the different videos; and
producing a recommendation for a workflow of the business process management system related to the single repetitive instance of work based on the patterns.

10. The method of claim 1, further comprising:
analyzing different videos showing a plurality of different people each performing a plurality of repetitive cycles of a single repetitive instance of work being performed in the place of business;
for each of the different people, identifying person specific patterns within the single repetitive instance of work from the analyzing of the different videos; and
generating feedback customized for each of the different people, wherein the feedback indicates a how each of the different people performs the repetitive instance of work relative to a person independent baseline for performing the repetitive instance of work.

11. The method of claim 1, further comprising:
identifying a plurality of different videos, each showing the work being performed in the place of business at different recorded points of time over a range of time;
analyzing each of the different video;
identifying time varying patterns within the work when analyzing the different videos; and
determining at least one trend in the work over the range of time from the time varying patterns.

12. The method of claim 1, further comprising:
identifying a plurality of different videos from different related businesses, each showing work being performed;
analyzing each of the different videos;
identifying business specific patterns within the work when analyzing the different videos; and
generating feedback customized for each of the different related businesses that includes the business specific patterns.

13. The method of claim 1, wherein the business processes of the business process management system are written in a standardized business process execution language (BPEL) language, which is independent of and functional across a plurality of different computing platforms.

14. The method of claim 2, wherein the particular specification for the work is a specification needed to comply with an ISO 9000 based certification.

15. A computer program product comprising a computer readable storage medium having computer usable program code embodied therewith, the computer usable program code comprising:
computer usable program code stored in a tangible storage medium operable to analyze video of work being performed in a place of business;
computer usable program code stored in a tangible storage medium operable to detect patterns within images of the video when analyzing the video;
computer usable program code stored in a tangible storage medium operable to compare these detected patterns against existing patterns stored in a pattern library, where the existing patterns correspond to workflow items;
computer usable program code stored in a tangible storage medium operable to generate similarity scores for the detected patterns representing their affinity to the existing patterns;
computer usable program code stored in a tangible storage medium operable to utilize the similarity scores to determine which workflow items are present within the video; and
computer usable program code stored in a tangible storage medium operable to perform at least one task based on the workflow items present within the video, each performed task changing or referencing a workflow of a business process management system.

16. The computer program product of claim 15, wherein the performed task references at least one workflow of the business process management system that represents a particular specification for the work, wherein said performed task is for determining if an action captured within the video is performing to the particular specification.

17. The computer program product of claim 15, wherein the performed task provides a recommendation to be analyzed by a user, wherein the recommendation is for creating a new workflow or for editing an existing workflow.

18. A business process management system comprising:
a video processing tool for receiving workflow video data, said workflow video data showing work being performed in a place of business within a set of time sequenced images, for processing the workflow video data to determine business workflow patterns within the workflow video data; and
a workflow proposal engine for generating workflow proposal documents by correlating business workflow patterns determined by the business processing tool against business workflows managed by the business process management system, said video processing tool and said workflow proposal engine comprising computer program products stored on a tangible medium that are operable to run on hardware.

19. The business processes management system of claim 18, wherein the business process management system is operable to use the workflow video to facilitate automated actions for compliance with at least one business standard certification, said at least one business standard certification comprising an ISO 9000 based certification.

20. The business management system of claim 18, further comprising:
a data store of time related workflow video data, wherein said business management system is able to analyze the time related workflow video data to determine changes in the work being performed in the place of business overtime.

21. The business management system of claim 18, further comprising:
a data store of person related workflow video data, wherein said business management system is able to detect an identity of different people from the workflow video data and determine person specific patterns when processing the workflow video data, wherein the person specific patterns are annotated in at least a portion of the workflow proposal documents produced by the workflow proposal engine.

22. The business management system of claim 18, further comprising:
a workflow server for responding to requests utilizing the business workflow of the business management system, said workflow server comprising computer program products stored on a tangible medium that are operable to run on hardware, wherein said workflow server is operable to receive requests, each for a business workflow conforming to a business process model, wherein the business workflow comprises a plurality of tasks with interdependencies among the tasks, which by the interdependencies some of the tasks are able to be executed in parallel and others must be executed in series upon completion of other ones of the tasks, wherein the business workflows are hardware and platform independent, wherein the workflow server is operable to satisfy received requests by assigning tasks to a plurality of different service providers that provide software services, wherein each of the tasks are assigned to corresponding ones of the software services.
